(19) United States
(12) Patent Application Publication
(10) Pub. No.: US 2004/0158617 A1
(43) Pub. Date: Aug. 12, 2004

(54) Methods and systems for processing a link

(75) Inventors: Nicholas W. Shanny, Derry, NH (US); Eugene Barlow, Hingham, MA (US)

Correspondence Address: FOLEY HOAG, LLP, PATENT GROUP, WORLD TRADE CENTER WEST, 155 SEAPORT BLVD, BOSTON, MA, 02110, US

(73) Assignee: Trip Advisor, Inc., Needham, MA

(21) Appl. No.: 10/359,924

(22) Filed: Feb. 6, 2003

(51) Int. Cl. H04N 7/173; H04N 5/445; G06F 3/00

(52) U.S. Cl. 709/217; 725/112; 725/113; 709/219

(57) ABSTRACT

Methods and systems for directing a web browser to a URL, including displaying a selectable link(s), the selectable link(s) associated with the URL and processor instructions, and, based on selection of the link(s), executing the instructions to generate a post query to the URL for the data. In a second embodiment, the methods and systems include loading a first URL into the web browser, the first URL associated with the destination URL, and, after loading the first URL, directing the web browser to the destination URL. In a third embodiment, the methods and systems include requesting data associated with a first URL, based on data received from the request, constructing the destination URL, and, based on the constructed destination URL, directing the web browser to the destination URL.

### BACKGROUND

(1) Field

The disclosed methods and systems relate generally to processing links, and more particularly to retrieving data associated with links.

(2) Description of Relevant Art

The Internet includes various computers and computer networks that are interconnected through communications links, where a reference to a computer can be understood herein to be a microprocessor-controlled device, and the communications links can be understood to include wired and wireless links. The interconnected computers can exchange information via requests that use various services and/or protocols, such as electronic mail, Gopher, and the World Wide Web (“WWW”). Using the well-known client-server model, the WWW service can allow a client computer (referred to herein as a “client”) to request data from a server computer (e.g., web server or web site, referred to herein as a “server”), where such server can be identifiable by a Uniform Resource Locator (“URL”). The server can reply to the request by providing information and/or data associated with request.

Generally, a client can be equipped with a web browser (“browser”) that can be understood to be an application that can request and thereafter display web pages. Accordingly, to view a web page, a user can employ a browser to cause the client to generate a request (e.g., a HyperText Transfer Protocol (“HTTP”) request) that specifies a URL associated with a requested web page. The request can be forwarded to a server associated with the requested web page, and the server can thus respond to the client by transmitting or sending the requested web page to the client, generally for display by the client's browser.

Web pages can be defined by a document that include HyperText Markup Language (“HTML”), where HTML includes “tags” to direct the display of a web page. An HTML document can contain various tags to control a display of text, graphics, controls, and other features. The HTML document may contain references (e.g., “links”) to URLs of other web pages available on the server and/or other servers. Accordingly, in response to a web page request from a client as provided herein, a server can transmit an HTML document to the client/browser, where the HTML document provides the tags for displaying the web page. The client/browser can thus display the web page as provided by the HTML document.

For WWW servers, such as those associated with search engines, travel sites, research sites, and various other applications and embodiments that provide an HTML document that includes one or more links (e.g., hypertext link or another selectable word, object, picture that connects to another word, object, picture, etc.) that may be associated with one or more servers at one or more URLs, the HTML document can allow a user to “select” and/or otherwise designate a link to cause data/information from the link's associated URL to be displayed on the user/client's browser. In some instances, however, a link that associates with a URL may not be adequate to allow a requesting user/client to successfully request and/or receive information from the server. In some instances, a user may be provided with an error signal that indicates that the server was not found or is otherwise unavailable.

### SUMMARY

The disclosed methods and systems include a method of requesting data from a Uniform Resource Locator (URL), including displaying a selectable link(s), the at least one selectable link associated with the URL and at least one of a script(s), an applet(s), an application(s), and a processor instruction(s), and, upon selection of the selectable link(s), executing the script(s), the applet(s), the application(s), and/or the processor instruction(s), to generate a post query and/or another request to the URL. As provided herein, the request can include a post query, such as, for example, a HTTP post query. The selectable link(s) can include a visual representation(s) of the URL that can include text, a graphic(s), a button(s), and/or an image(s). The requested data can include a text document, an image, and/or an application, and can include, for example, a web page. Accordingly, the selectable link(s) can be provided by a first server, while the URL can be associated with a second server.

Executing the request can include associating a form with the URL and/or the selectable link(s), and, submitting the form upon selection of the at least one selectable link. Submitting the form can include executing a script(s), an applet(s), an application(s), and a processor instruction(s). Further, displaying the selectable link(s) can include displaying on a web page, where the web page is displayed using a web browser.

Accordingly, the disclosed methods and systems can include generating the selectable link(s) by associating the URL with a request such as a post query.

In an embodiment, the disclosed methods and systems include a method for directing a web browser to a destination Uniform Resource Locator (URL), including loading a first URL into the web browser, the first URL associated with the destination URL, and, after loading the first URL, directing the web browser to the destination URL. The URL can include text, a graphic(s), a button(s), and an image(s). Loading the first URL can include generating a frameset within the web browser, where the frameset can have at least one frame, and, loading the first URL in the at least one frame. One or more of the frames can be a hidden frame. Loading the first URL can include obtaining session information associated with the destination URL, where the session information can be a cookie.

The method can also include displaying a selectable link(s), where the selectable link(s) can be associated with a script(s), an application(s), an applet(s), and/or a processor instruction(s), and, where directing the web browser includes executing the script(s), the applet(s), the application(s), and the processor instruction(s) to direct the web browser to the destination URL. In an embodiment, the method can include displaying a selectable link(s) that can be associated with the first URL and a script for loading the destination URL, and, based on a selection of the selectable link(s), returning a frameset to the web browser for loading the first URL. The directing can include directing based on executing the script(s), application(s), applet(s), and/or instruction(s).

In one embodiment, the loading a first URL can include providing a frameset configured to request a resource from the first URL, and directing the web browser can include executing a method to notify a script method to direct the web browser to the destination URL.

The first URL and the destination URL can be the same URL, and/or can be associated URLs based on session information.

In the disclosed systems and methods, directing the web browser can include executing a post query to the destination URL.

Also disclosed is a method of directing a web browser to a destination URL, where the method includes requesting data associated with a first URL, the first URL being associated with the destination URL, based on data received from the request, constructing the destination URL, and, based on the constructed destination URL, directing the web browser to the destination URL. The URL can include text, a graphic(s), a button(s), and/or an image(s).

Constructing the destination URL can include constructing the URL based on a query and/or a scan of the requested data. The constructing can thus include executing an application to perform the query and scan of the received data. The method can also include displaying a selectable link(s) that can be associated with the first URL and/or the destination URL.

Accordingly, the method includes receiving a request for the destination URL, and thus, requesting the first URL can be based on receiving a request for the destination URL. In an embodiment, the method can include displaying a selectable link(s) associated with a partially complete representation of the destination URL, and therefore constructing the destination URL can include completing the representation of the destination URL.

For the disclosed methods and systems, the requesting can be performed from a server and/or a client, where the web browser executes on the client. Further, the directing can include: (i) directing based on a server requesting data based on the constructed destination URL, where the web browser executes on a client, and the server provides the client with data from the constructed destination URL, and, (ii) directing based on a client requesting data based on the constructed destination URL, where the constructed destination URL is provided by at least one of: the client and a server.

The methods and systems can include loading the first URL into the web browser before directing the web browser to the destination URL. Loading the first URL can include providing the web browser with a frameset having at least one frame, where the frame(s) can be configured to load the first URL. One or more of the frame(s) can be hidden.

The methods and systems can also include loading a second URL into the web browser before directing the web browser to the destination URL, where the second URL can be associated with the destination URL.

As provided herein, directing can include executing a script(s), an applet(s), an application(s), and/or a processor instruction(s) to load the constructed destination URL. Further, the received data can be URL data and/or data associated with the destination URL. The first URL can be the same as the destination URL, and/or associated with the destination URL.

Other objects and advantages will become apparent hereinafter in view of the specification and drawings.

### BRIEF DESCRIPTION OF THE DRAWINGS

FIG. 1 illustrates one embodiment for a system architecture according to the disclosed methods and systems;

FIG. 2 is a block diagram presenting some components for processing a link;

FIG. 3 illustrates block diagrams for processing a link;

FIG. 4 is a block diagram for executing a post query to process a link;

FIG. 5 is a block diagram for a session embodiment; and,

FIG. 6 is a block diagram for a data embodiment.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

The disclosed methods and systems relate to processing a link, where a link can represent a Uniform Resource Locator (URL). Accordingly, a link can be a Hyper Text Transfer Protocol (HTTP) link, although the disclosed methods and systems are not limited to HTTP links, and can employ other links that include text, buttons, graphics, and/or an image(s), including for example a hypertext link that can employ a hypertext reference (HREF), where as provided herein, such link(s) represents a URL. In the disclosed methods and systems, a link can be selected via a voice command, cursor selection, stylus selection, keyboard selection, and/or other selectable means, where link selection can generate a request for a resource (e.g., image, text, file, and/or application, etc.) such as a web page, where the web page can be loaded into and/or display by a web browser that is associated with the device/client that requested the resource. In an example where the resource is a web page, a user viewing or otherwise “using” a web browser can view a first web page (e.g., on a client device), where the web page has one or more selectable links, whereupon the user can select a link associated with a second web page to cause the second web page to be loaded into (e.g. requested, retrieved, and displayed) the web browser.

For the disclosed methods and systems, “directing” a web browser to this second web page and/or URL (“destination URL”), and/or “loading” the destination URL, can be understood to include requesting a resource from the destination URL, and receiving the resource in response to the request, where the resource can be an image, application, file, and/or a document such as an HTML document, and may otherwise be known as a web page. Accordingly, in some embodiments, “directing” and/or “loading” can include requesting the resource, where the requesting is performed by a client (device), and thereafter the client receiving a data transfer from a server associated with the destination URL. As will be provided herein, in some embodiments, “loading” a resource may not necessarily include a display and/or a rendering of the information in a web browser or otherwise. For the disclosed embodiments, the request for the resource can be communicated to the destination URL by a first processor-device associated with the web browser (e.g., client, in one embodiment, via HTTP request), or the request for the resource can be communicated to the destination URL by a second processor-device (e.g., web server) in communications with the first processor device. Additionally and/or optionally, the data transfer (e.g., requested resource) from the destination URL can be provided directly to the first processor-device, or via the second processor-device and thereafter to the first processor-device. References herein to the destination URL can include a server(s) associated with the destination URL.

It can also be understood that although the illustrated embodiments of the disclosed methods and systems include examples related to requesting data using the HTTP protocol and using, for example, HTTP requests, HTTP post queries, etc., the disclosed methods and systems are not limited to the HTTP protocol, and thus such “requests,” otherwise known as “gets,” can be understood to be applicable to other networking and/or communications protocols that may be used in communicating between the various system components as provided herein.

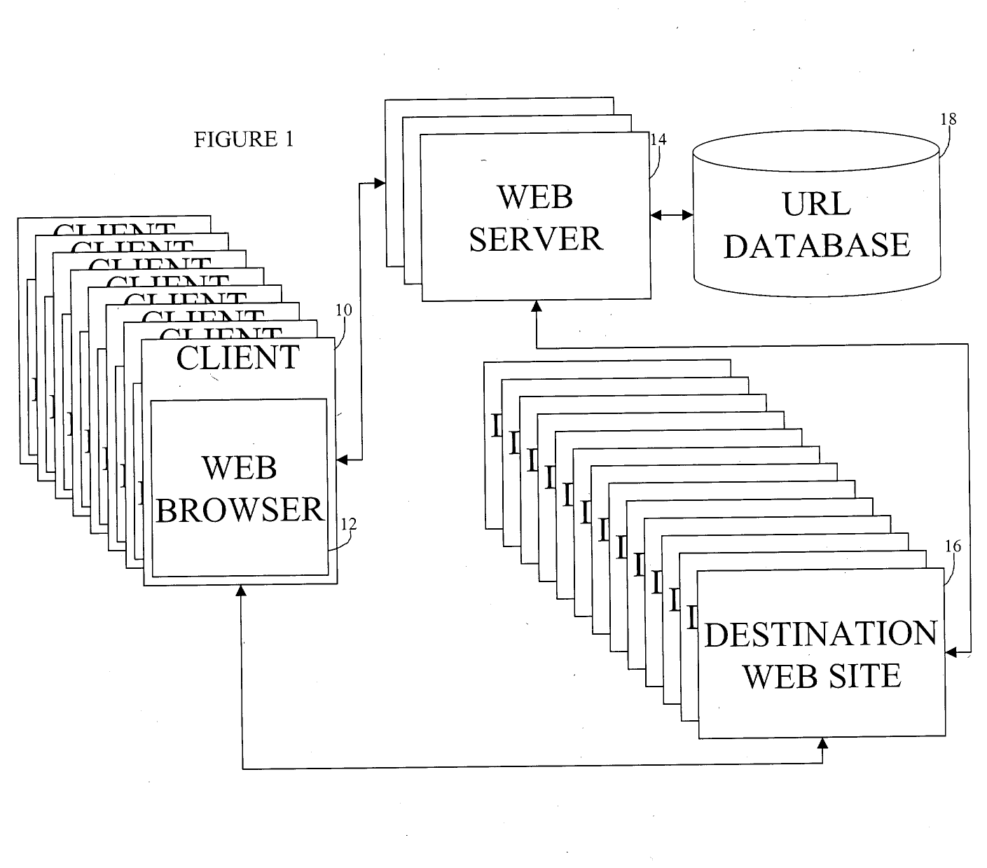

FIG. 1 is a diagram providing one system architecture that can be applicable to the disclosed methods and systems. As the exemplary FIG. 1 system indicates, one or more clients 10, or processor-controlled devices, can be equipped with a web browser 12 for viewing web pages and accessing other resources that may be available via one or more networks such as an intranet(s) and/or the internet. In one illustrated embodiment of the FIG. 1 system, the web browser 12 can present a web page that can include one or more selectable links, where the web page can be provided by a web server 14. Those of ordinary skill will understand that the illustrated “web server” 14 is a server as is known in the art (e.g., a processor-controlled device), with the descriptive “web server” annotation and reference provided merely for explanatory purposes to indicate that such server 14, in the illustrated embodiment, provides the client 10 a web page (e.g., HTML document), for display in the web browser 12, where the web page can include or otherwise have one or more selectable links. As provided herein, the selectable link(s) in the web page can and also be associated with one or more destination web sites and/or servers 16 that can reside at URLs represented by the selectable links, and where such servers 16 can be distinct from the web server 14 that provides the selectable link(s). One of ordinary skill will accordingly understand that the FIG. 1 “destination web sites” 16 can be understood to be associated with one or more URLs having resources that can be requested by the clients 10 via a selectable link. It can thus be understood that the web page, and/or the selectable links, can be provided by a first server (e.g., the web server 14), for display on a client 10 that can be a server, while the URLs that the selectable links represent can be associated with one or more distinct second servers (e.g., the destination web sites/URLs 16).

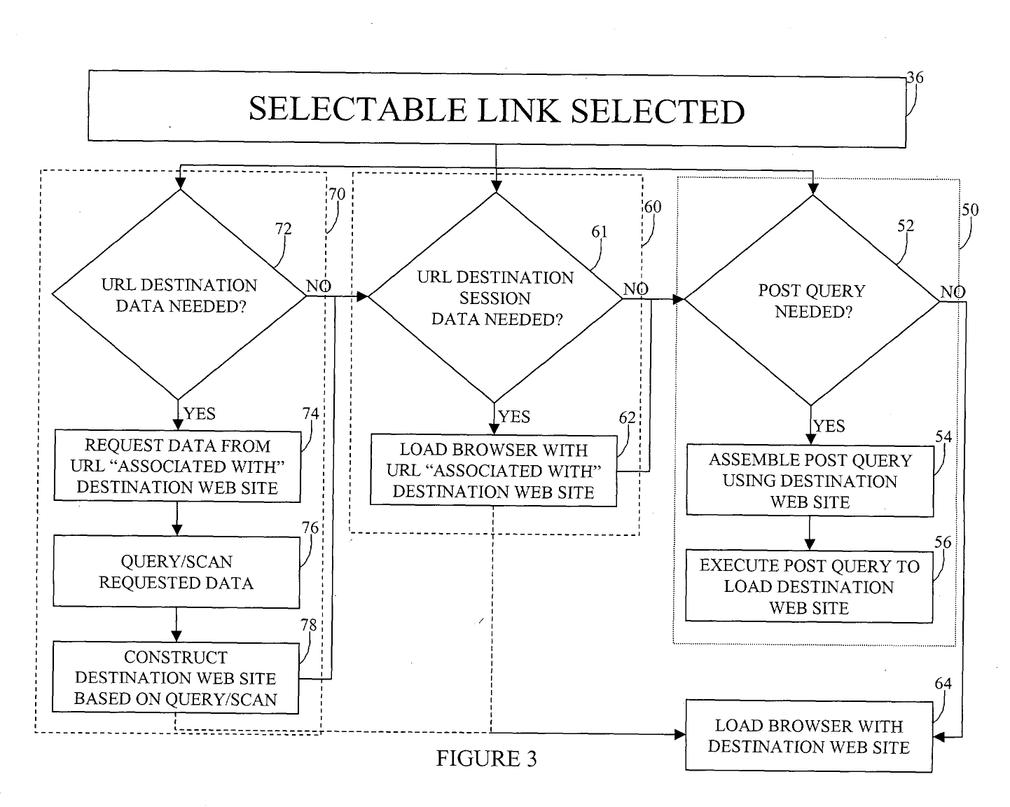

As the FIG. 1 embodiment also indicates, the disclosed methods and systems can include a “URL database” 18 that can be understood herein to be a database that can be accessed by the web server 14 to provide data and/or other information with regard to linking to destination web sites 16, and specifically, generating selectable links to the destination web sites 16 such that link selection can cause the web browser 12 to load (e.g, request, receive) a web page associated with the destination URL/web site 16 to which the selectable link is associated. Accordingly, in one embodiment, the disclosed methods and systems can include collecting information via online or other databases, web crawlers, manual input, and other means to provide information on generating selectable links to the destination web sites 16. Such information can be employed by the web server 14 in generating selectable links to the destination web site URLs, where such selectable links can be incorporated in a web server web page that is presented on a client 10 using a web browser 12. For example, a destination web site 16 and/or URL associated therewith can be further associated with computer instructions (“code”), a post query, and/or another URL, for example. In one embodiment, based on the data that the URL database 18 associates with a destination web site and/or URL, the web server 14 can generate a selectable link to allow processing of such selectable link as provided herein according to FIGS. 3-6, such that a request for data associated with the URL can provide a successful transfer of data to the requesting device.

As provided previously herein, it can be understood that the different embodiments of the disclosed methods and systems that employ communications links, including those communicative links illustrated in FIG. 1, can employ one or more communications protocols, including but not limited to wired and/or wireless communications protocols.

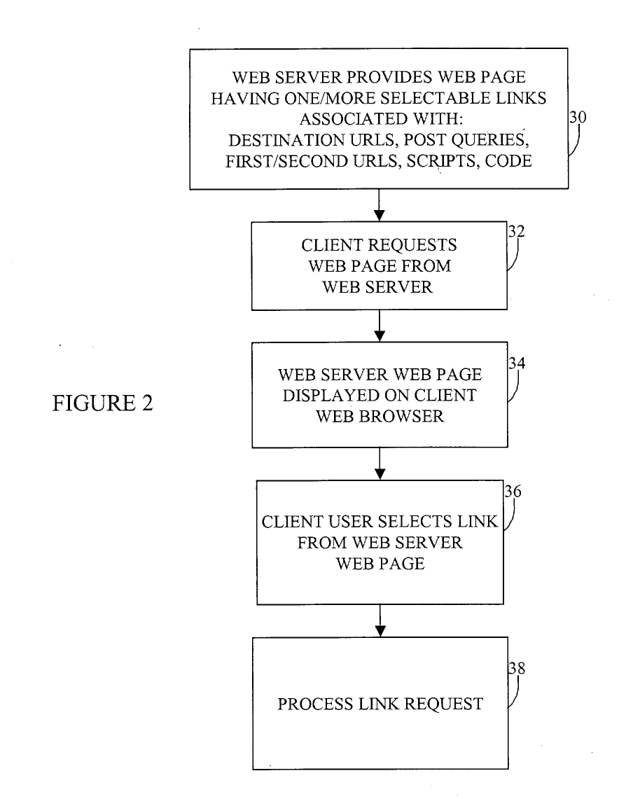

FIG. 2 provides a block diagram illustrating some pre-processing that can be performed for a system according to FIG. 1, prior to processing a selectable link. As FIG. 2 indicates, the web server 14 can generate and/or otherwise provide 30 a web page to a client 10 for display on a web browser 12, where the one or more selectable links can be representative of URLs associated with the destination URLs/web sites 16. The links can thus be generated based on data associated with the destination web sites/URLs 16, where such associated data can be provided by the URL database 18. As provided herein, associated data can include, but is not otherwise limited to, post query data, metadata, one or more associated URLs, scripts, computer instructions (“code”), and other data. Accordingly, the links can be provided 30 when a client 10 requests 32 a web page from the web server 14. The web page with the selectable links, generated by the web server 14, can be displayed 34 on a web browser 12 at the client 10, whereupon a user or another associated with the client 10 can select 36 one of the links to cause the link to be processed 38 such that the URL associated with the link, and/or the destination URL 16, can be downloaded (e.g., requested and/or retrieved) and presented to the web browser 12.

FIG. 3 presents three embodiments 50, 60, 70 for generating and/or processing a link according to the disclosed methods and systems, where as FIG. 3 indicates, the three embodiments 50, 60, 70 can be employed individually and/or in combination. In a first embodiment 50, a destination URL can be associated with a post query, and accordingly, a selectable link can be generated for the destination URL such that when the link is selected, instructions such as a script can be executed to execute the post query and hence provide the destination web site/URL 16 with metadata to allow the destination web site 16 to provide the web page (or other resource) associated with the destination URL. In one embodiment, such metadata can reside in the URL database 18 to allow for selectable link generation/processing. Further, in some embodiments, the URL database 18 can associate the metadata and/or destination URL with a script (e.g., Java, VB, etc.), application, applet, and/or other computer instructions such that the link selection can activate the script, etc., to cause the post query to be executed. Accordingly, with reference to FIG. 3, for destination URLs where a post query is needed to download the destination URL 52, a selectable link can be generated to assemble 54 the post query with the appropriate metadata, etc., and execute 56 the post query upon selection of the link.

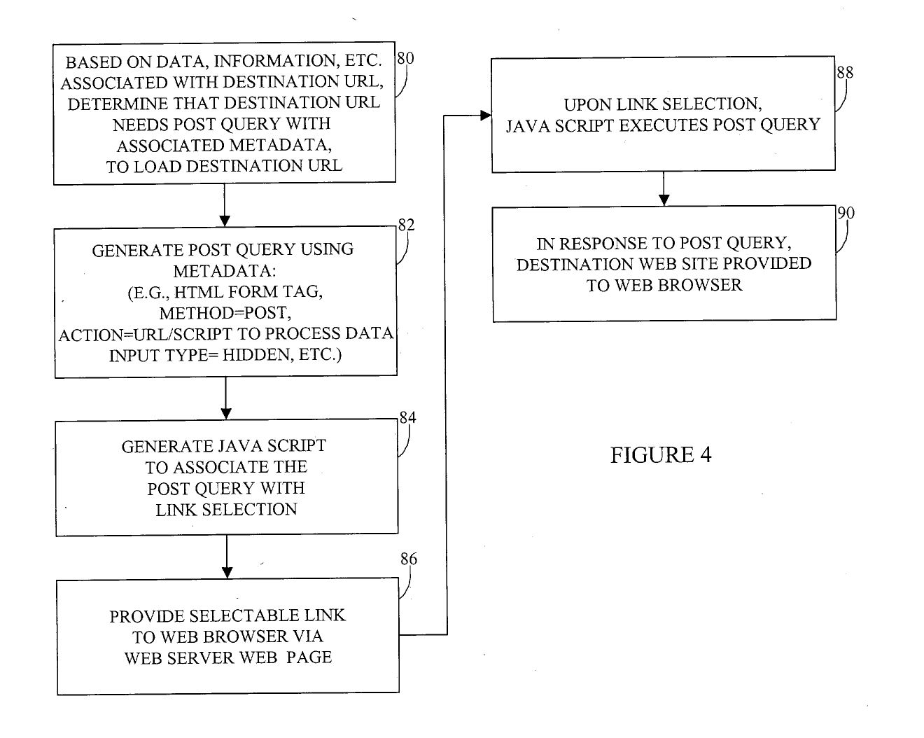

In some embodiments, the post query can be a request in the form of an HTTP post query, but those of ordinary skill will recognize that other post queries and/or other forms of requests that provide the metadata can be employed, based on the embodiment. Such an HTTP/HTML embodiment can be illustrated in FIG. 4, where based on the destination URL and data associated therewith via the URL database 18, it can be determined that a post query may be needed to request and/or retrieve a resource (e.g., a web page) from the destination URL 80. Accordingly, the web server 14, for example, can be configured (e.g., can include processor instructions), in such instances, to generate a post query 82 for association with the selectable link, such that the post query can be executed to provide metadata to the destination URL such that the destination URL may respond to the request for a resource and/or web page.

Those of ordinary skill in the art will recognize that in one embodiment, a post query can include invoking a submit method for a form associated with the destination URL, and thus in an HTML embodiment, can include employing an HTML FORM tag where the METHOD attribute can be a POST and the ACTION attribute can be a script and/or partial URL associated with the destination URL/web page. In an embodiment, the INPUT tag TYPE attribute can also be HIDDEN, but may not be, and the VALUE attributes can be set to the value to allow the destination URL/web site to respond to the request. In the illustrated embodiment, JavaScript instructions and/or a method can be used to associate the post query with a selectable link 84, such that the JavaScript instructions can be invoked to execute the script when the link is selected. Accordingly, a web server 14 can provide.86 a web page to a web browser 12, where the web page includes the selectable link. Upon link selection 88, the JavaScript and/or other instructions can be invoked to assemble and execute the post query 90 (e.g., submit the form) such that the destination URL/web site responds to the request to display an associated web page (and/or otherwise provide the requested resource) on the web browser 12. As provided previously herein, FIG. 4 is one embodiment where the resource is a web page, a script is used, and the post query is HTML-based, however those of ordinary skill will recognize that such example is provided for illustration and not limitation.

Referring again to FIG. 3, in a second embodiment 60 termed herein as the “session embodiment”, the URL database 18 or other information source can indicate to the web server 14 that a given destination URL desires session information (e.g., a cookie) before allowing the destination URL resource/web page to be downloaded and/or otherwise provided via a request, to, for example, a web browser 12. In some embodiments, an incomplete and/or unsuccessful retrieval and/or loading of a requested resource from the destination URL may nonetheless be effective in providing the session information to the web browser, such that a subsequent request for retrieval of the resource from the same client, to the same destination URL, may be complete and/or successful in communicating the requested resource. Accordingly, the session embodiment 60 includes requesting and retrieving a resource associated with a first URL, where the first URL may be the same as the destination URL, and/or associated with the destination URL. It may be understood that an associated URL can be determined based on session information, and accordingly, the associated, “first” URL may be a URL that provides session information that allows the resource at the destination URL to be successfully retrieved and/or requested.

In one example of the session embodiment 60 for an architecture according to FIG. 1, for example, the URL database 18 can include and/or associate such first URL with the destination URL to allow the web server 14 to generate a selectable link which, when selected, causes the first URL to be loaded 62 into the web browser 12, and thereafter causes the destination URL to loaded 64 into the web browser 12. As will be provided herein, the session embodiment 60 can be performed using a frameset with a single frame, and in some embodiments, can employ a frameset with multiple frames (e.g., two frames), where additionally and/or optionally, one or more of the frames can be a hidden frame.

In one illustrative embodiment of the session embodiment that includes a system architecture according to FIG. 1, based on a destination URL/resource that is associated with a need for session information, the web server 14 can generate a selectable link which, when selected, processes and/or generates a request to the web server 14 where such request can include identification and/or other data that the web server 14 can associate with the destination URL. In one embodiment, based on the received identification data, the web server 14 can query the URL database 18 to determine that session information is needed to direct the web browser 12 to the destination URL (e.g., request and retrieve a web page), and that such session information can be obtained via a first URL associated with the destination URL. Accordingly, the web server 14, for example, can return a HTML frameset to the web browser 12, where the frameset can include one or more frames, and can include in one embodiment, a hidden frame to load the first URL and thus obtain the session information (e.g., “seed” with web browser) needed by the destination URL. Accordingly, in such an embodiment, the hidden frame can be configured to load the destination URL, and upon loading the first URL, a script, applet, computer instructions, etc., associated with the destination URL and/or selectable link can be configured to execute and thus redirect the web browser 12 to the destination URL. In some embodiments, execution of the script can cause the hidden frame and/or frameset to be deleted. Because the first URL provided the session information to the web browser 12, the destination URL can be loaded to the web browser 12. As provided previously herein, the first URL and destination URL can be the same URL, or may be different URLs.

Accordingly, with reference to the second embodiment 60 of FIG. 3, when session information is needed to retrieve a resource/web page from a destination URL 61, the web browser 12 can be loaded 62 with a first URL that is associated with the destination URL, the first URL providing session information for the destination URL; and, upon loading the first URL/session information, the destination URL can be retrieved and/or otherwise loaded 64 into the web browser 12.

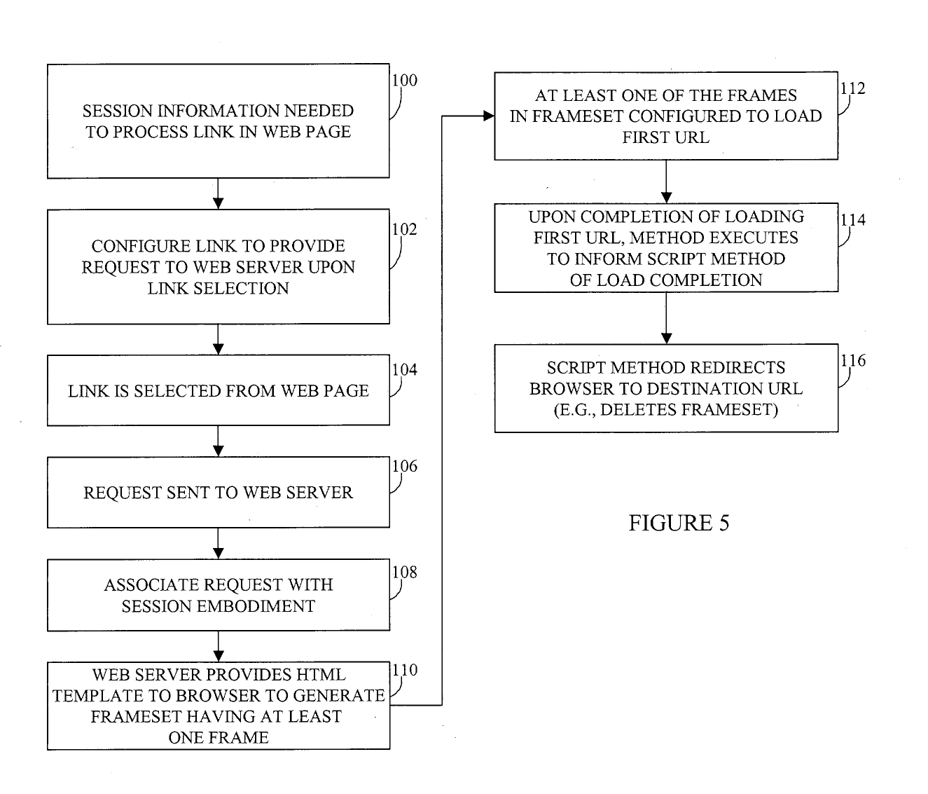

FIG. 5 provides one embodiment for a session embodiment. As FIG. 5 indicates, the web server 14 can, in generating a web page, utilize the URL database 18 to determine that a given destination URL to which a web page can include a link, needs session information 100. In the illustrated embodiment, the link can be configured 102 to provide a request to the web server 14 upon link selection. Accordingly, when the link is selected 104, the web server 14 can receive 106 a request, and based on information and/or data associated with the request, the web server 14 can associate 108 the request with a session embodiment, utilize an HTML template 110 to generate a frameset in the web browser 14 that can include one or more frames, including a hidden frame, and to redirect 112 the hidden frame and/or another frame in the frameset to a first URL that is associated with the destination URL, and may be the same or different from the destination URL. Upon completion of loading the first URL, a method and/or processor instructions, etc., can execute 114 to inform a script method, applet, processor instructions, etc., that the first URL load is complete and that the web browser 14 can thus be redirected 116 (e.g., by the script) to the destination, URL (e.g., request a web page). Such redirection 116 can delete the aforementioned frameset having one or more (hidden) frames.

Referring to FIG. 1 with respect to the session embodiment 60, those of ordinary skill will recognize that the URL database 18, for example, can associate the destination with the first URL from manual input, web crawler, and/or other collected data. In the case of the session embodiment 60 where the first URL is loaded into a frame, for example, a first URL may be selected by a system administrator or another associated with the web server 14 and/or database 18 such that the first URL provides the session information for the destination URL, and also, the first URL can be loaded by the web browser 12 in a timeframe according to the embodiment. In one embodiment, for example, a first URL may be chosen from amongst several URLs based upon the speed of loading. Other considerations may also be evaluated in determining a first URL. In some embodiments, multiple “first” URLs may be provided. These considerations for selecting a first URL can also be applicable to the third embodiment 70.

With further regard to the session embodiment 60, it can also be understood that variations for generating the selectable link, and hence loading the first URL and destination URL, can be employed. For example, although the aforementioned embodiment included a selectable link that generated a request to the web server 14 which then communicated a HTML frameset to the web browser 12, in some embodiments, the selectable link can be generated such that the HTML frameset may be generated via a script and/or other instructions, and similarly, loading of the first and destination URLs can be performed without placing a request to the web server 14. These variations in allocating features and/or components of the disclosed methods and systems amongst various system components may also be applied to the third embodiment 70.

Those of ordinary skill will also understand that a selection of one or multiple frames, hidden frames, etc., can be based on the embodiment.

In a third embodiment 70 illustrated in FIG. 3, referred to herein as the “data embodiment,” a destination URL can be understood as needing specific information and/or data 72 to generate the destination URL. Accordingly, prior to link selection, the “destination URL” may be partially known. To complete the destination URL, data from a first URL that is associated with the destination URL, which may be the same or different from the destination URL, can be requested and retrieved 74, and scanned and/or queried 76 for data to complete the URL. The destination URL can thereafter be constructed 78.

In one embodiment, the constructed destination URL can be provided to and/or loaded 64 into the web browser 12 such that the web browser 12 can request and retrieve the associated resource/web page based on the constructed destination URL. In another embodiment, another server, such as the web server, can request the web page based on the constructed destination URL, and provide the web page to the web browser 12 in response to a link selection.

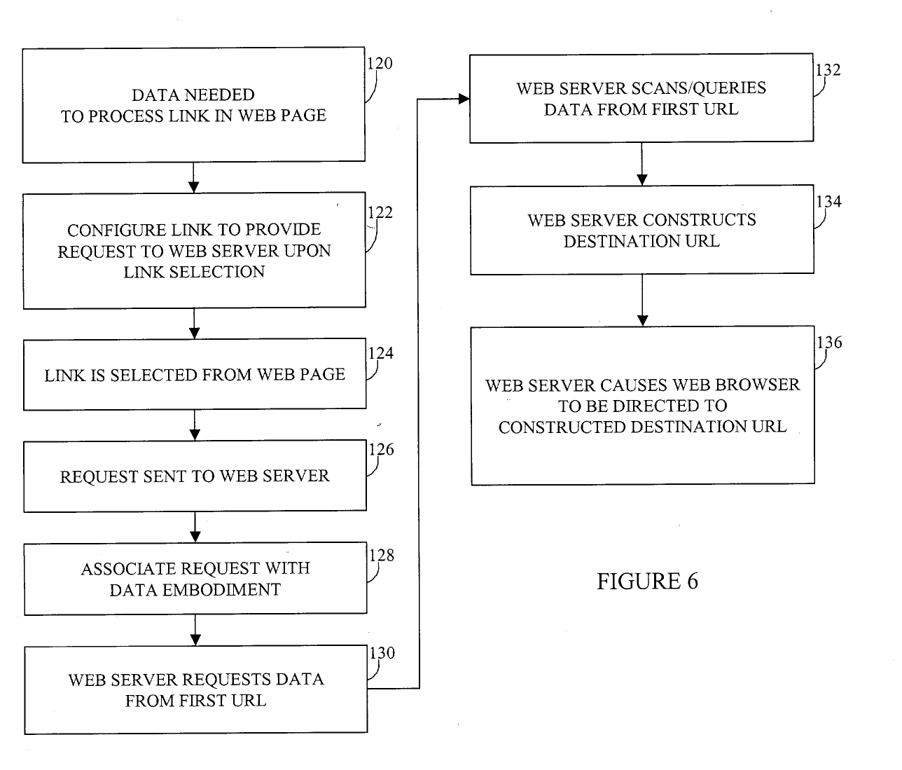

With reference to FIGS. 3 and 6, in one embodiment of the data embodiment 70, a web server 14 can associate a destination URL as a URL needing further data to complete 120 the URL address, and thus the web server 14 can generate a selectable link 122 for presentation on the web browser 12 via a web page, where upon link selection 124, a request can be provided 126 to the web server 14 with identification and/or other data from which the web server 14 can access the URL database 18 to determine 128 that the destination URL needs additional data 72 to complete the destination URL. In one embodiment, the web server 14 can request data 74, 130 from the first URL associated with the destination URL, and invoke a script, applet, application, and/or other processor instructions to scan and/or query 76, 132 the data received from the first URL. It can thus be understood, as provided previously herein, that the request to the first URL can be configured in accordance With a protocol compatible with a server(s) associated with the first URL, and can include, for example, a HTTP post query, a HTTP request, a File Transfer Protocol (“ftp”) get, etc. In one embodiment, the data received in response to the request can be text data (e.g., HTML document) and/or other data. For example, the URL database 18 can indicate which applet, application, etc., may be used to request and/or scan the received data, and/or the database 18 can indicate the data that should be queried/scanned to complete/construct the destination URL. As provided herein, based on the query/scan, the destination URL can be constructed 78, 134.

The web browser 12 can thereafter be configured 136 with the data from the constructed destination URL in several manners. In one embodiment, the web server 14 can provide the constructed destination URL to the web browser 12 to redirect the web browser 12 to the destination URL (e.g., the web browser 12 requests and receives the destination URL resource/web page). In an embodiment, the web server 14 may request the resource from the constructed destination URL, and provide the resource (e.g., HTML stream) to the web browser 12. As will be provided herein, for embodiments that employ the data 70 and session 60 embodiments, the latter method of configuring the web browser with the constructed destination URL, may not be preferred.

In some embodiments, during the request 74, scan 76, and/or construct 78 processing, the web browser 12 can be directed by the web server 14 to display a web page that indicates that processing is being performed.

As FIG. 3 indicates, the various link processing embodiments 50, 60, 70 can be employed individually and/or in combination. Accordingly, in one embodiment, a destination URL may need data to complete the destination URL, and may also need session information, thereby indicating a combination of the data and session embodiments 60, 70. In such an embodiment, it may be understood that a “first URL” that may provide the data for constructing the destination URL (data embodiment 70), may be different from a “first URL” that can be pre-loaded before the (constructed) destination URL in the session embodiment 60. Accordingly, a single “destination URL” can be associated with multiple “first URLs.” Other combinations of the three embodiments may also be employed, and thus the URL database 18 can provide the associations of data as needed to generate and/or process the selectable links as provided herein with respect to one or more of the three embodiments 50, 60, 70. Further, those of ordinary skill will understand that the FIG. 3 representation is illustrative and as provided herein, some of the processing indicated in FIG. 3 may occur before link selection 36 (e.g., during link generation), and as such, FIG. 3 is merely illustrative of some processing to represent the three embodiments, regardless of processing order.

It can thus be understood that the three embodiments shown in FIG. 3 can be implemented in various ways. For example, as provided herein, one or more of the three embodiments 50, 60, 70 can employ selectable links that can be generated and/or configured by the web server 18 to include scripts that can be executed (e.g., upon selection) to perform operations, and/or the selectable links can be configured to redirect requests to the web server 18 which can then process the requests accordingly.

What has thus been described are methods and systems for directing a web browser to a URL, including displaying a selectable link(s), the selectable link(s) associated with the URL, and, directing the web browser to the URL by executing a post query upon selection of the selectable link(s). In a second embodiment, the methods and systems include loading a first URL into the web browser, the first URL associated with the destination URL, and, after loading the first URL, directing the web browser to the destination URL. In a third embodiment, the methods and systems include requesting data associated with a first URL, the first URL being associated with the destination URL, based on data received from the request, constructing the destination URL, and, based on the constructed destination URL, directing the web browser to the destination URL.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices (“processor devices”) that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet.

Although the methods and systems have been described relative to a specific embodiment thereof, they are not so limited. Obviously many modifications and variations may become apparent in light of the above teachings. For example, the scripts, processor/computer instructions, applets, etc., that can be utilized, can use a variety of scripting (e.g., Java, VB, etc.) and other processor high level (e.g., Java, C++, C, etc.) and/or assembly level instruction schemes. Similarly, although the methods and systems have been described relative to illustrative embodiments that include resources such as web pages which are displayed via a web browser, those of ordinary skill will understand that the methods and systems can be applied to other resources (e.g., images, text, applications, etc.) and may not include display on a web browser.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method of requesting data from a Uniform Resource Locator (URL), the method comprising:
displaying at least one selectable link, the at least one selectable link associated with the URL and at least one of: at least one script, at least one applet, at least one application, and at least one processor instruction, and,
upon selection of the at least one selectable link, executing at least one of: the at least one script, the at least one applet, the at least one application, and the at least one processor instruction, to generate a post query to the URL.

2. A method according to claim 1, where the at least one selectable link is provided by a first server, and the URL is associated with a distinct second server.

3. A method according to claim 2, where displaying includes displaying at a client.

4. A method according to claim 1, where the post query includes a HTTP post query.

5. A method according to claim 1, where the at least one selectable link includes at least one visual representation of the URL.

6. A method according to claim 1, where the at least one visual representation includes at least one of: text, at least one graphic, at least one button, and at least one image.

7. A method according to claim 1, where the data includes at least one of a text document, an image, and an application.

8. A method according to claim 1, where executing includes:
associating a form with at least one of the URL and the at least one selectable link, and,
submitting the form upon selection of the at least one selectable link.

9. A method according to claim 8, where submitting the form includes executing at least one of:
at least one script, at least one applet, at least one application, and at least one processor instruction.

10. A method according to claim 1, where displaying includes displaying the at least one selectable link on~a web page, where the web page is displayed using a web browser.

11. A method according to claim 1, further comprising generating the at least one selectable link by associating the URL with a post query.

12. A method for directing a web browser to a destination Uniform Resource Locator (URL), the method comprising:
loading a first URL into the web browser, the first URL associated with the destination URL, and,
after loading the first URL, directing the web browser to the destination URL.

13. A method according to claim 12, where the URL includes at least one of: text, at least one graphic, at least one button, and at least one image.

14. A method according to claim 12, where loading the first URL includes:
generating a frameset within the web browser, the frameset having at least one frame, and,
loading the first URL in the at least one frame.

15. A method according to claim 14, where at least one of the at least one frame is a hidden frame.

16. A method according to claim 12, where loading the first URL includes obtaining session information associated with the destination URL.

17. A method according to claim 16, where obtaining session information includes obtaining a cookie.

18. A method according to claim 12, further comprising:
displaying at least one selectable link, where the at least one selectable link is associated with at least one of a script, an application, an applet, and at least one processor instruction, and,
where directing the web browser includes executing at least one of the script, the applet, the application, and the at least one processor instruction to direct the web browser to the destination URL.

19. A method according to claim 12, further comprising:
displaying at least one selectable link, the at least one selectable link associated with the first URL and a script for loading the destination URL, and,
based on a selection of the at least one selectable link, returning a frameset to the web browser for loading the first URL.

20. A method according to claim 19, where directing includes directing based on executing the script.

21. A method according to claim 12, where loading a first URL includes providing a frameset configured to request a resource from the first URL.

22. A method according to claim 12, where directing the web browser includes executing a method to notify a script method to direct the web browser to the destination URL.

23. A method according to claim 12, where the first URL and the destination URL are at least one of: the same URL, and associated URLs based on session information.

24. A method according to claim 12, where directing the web browser includes executing a post query to the destination URL.

25. A method of directing a web browser to a destination URL, the method comprising:
requesting data associated with a first URL, the first URL being associated with the destination URL,
based on data received from the request, constructing the destination URL, and,
based on the constructed destination URL, directing the web browser to the destination URL.

26. A method according to claim 25, where the URL includes at least one of: text, at least one graphic(s), at least one button, and at least one image.

27. A method according to claim 25, where constructing the destination URL includes constructing the URL based on at least one of a query and a scan of the requested data.

28. A method according to claim 27, where constructing includes executing an application to perform the query and scan of the received data.

29. A method according to claim 25, further comprising displaying at least one selectable link, the at least one selectable link associated with at least one of: the first URL and the destination URL.

30. A method according to claim 25, further comprising receiving a request for the destination URL, and where requesting the first URL is based on receiving a request for the destination URL.

31. A method according to claim 25, further comprising displaying at least one selectable link associated with a partially complete representation of the destination URL.

32. A method according to claim 31, where constructing the destination URL includes completing the representation of the destination URL.

33. A method according to claim 25, where requesting includes requesting from at least one of a server and a client, and where the web browser executes on the client.

34. A method according to claim 25, where directing includes at least one of:
directing based on a server requesting data based on the constructed destination URL, where the web browser executes on a client, and the server provides the client with data from the constructed destination URL, and,
directing based on a client requesting data based on the constructed destination URL, where the constructed destination URL is provided by at least one of: the client and a server.

35. A method according to claim 25, further comprising:
loading the first URL into the web browser before directing the web browser to the destination URL.

36. A method according to claim 35, where loading the first URL includes providing the web browser with a frameset having at least one frame, where the at least one frame is configured to load the first URL.

37. A method according to claim 36, where at least one of the at least one frame is hidden.

38. A method according to claim 25, further comprising:
loading a second URL into the web browser before directing the web browser to the destination URL, the second URL associated with the destination URL.

39. A method according to claim 25, where directing includes executing at least one of a script, an applet, an application, and at least one processor instruction to load the constructed destination URL.

40. A method according to claim 25, where the received data is at least one of URL data and data associated with the destination URL.

41. A method according to claim 25, where the first URL is at least one of: the same as the destination URL, and associated with the destination URL.
